(19) United States
(12) Patent Application Publication
(10) Pub. No.: US 2009/0155694 A1
(43) Pub. Date: Jun. 18, 2009

(54) CATHODE AND LITHIUM BATTERY USING THE SAME

(75) Inventor: Kyu-sung PARK, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/118,963

(22) Filed: May 12, 2008

(30) Foreign Application Priority Data
Dec. 18, 2007 (KR) 2007-133605

(51) Int. Cl. H01M 4/40

(52) U.S. Cl. 429/231.95

(57) ABSTRACT

A cathode including a current collector and a cathode active composition coated on the current collector. The cathode active composition includes a conducting agent, a binder, and a cathode active material. The cathode active material includes a solid-solution composite oxide represented by the Formula xLi2MO3-(1−x)LiMeO2, in which 0<x<1, and M and Me are each independently at least one metal selected from the group consisting of Mn, Ti, Zr, V, Cr, Mn, Fe, Co, Ni, Cu, Al, Mg, Zr, B, and Mo; and an electrochemically inactive material that is surface-coated with carbon.

### CROSS-REFERENCE TO RELATED APPLICATION

This application claims the benefit of Korean Application No. 2007-133605, filed Dec. 18, 2007, in the Korean Intellectual Property Office, the disclosure of which is incorporated herein by reference.

### BACKGROUND OF THE INVENTION

1. Field of the Invention

Aspects of the present invention relate to a cathode, and a lithium battery using the same, and more particularly, to a cathode having improved cycle characteristics and a high capacity, and a lithium battery using the same.

2. Description of the Related Art

In general, transition metal compounds, such as LiNiO₂, LiCoO₂, LiMn₂O₄, LiFePO₄, LiNiₓCoₓ₋₁O₂(0<x<1), and LiNiₓMnₓCo₁₋₂ₓO₂(0<x<0.5) are widely used as cathode active materials for lithium batteries. Next generation lithium batteries can be produced by improving high-rate discharge performance and high discharge capacity characteristics of the cathode active materials. As portable electronic devices gain additional functionality, high performance lithium secondary batteries are highly sought after. To address these concerns, along with the design of battery systems, and advanced battery manufacturing technology, improvements in battery materials are being developed.

For example, various composite oxides have been presented, to solve the ever increasing demand for higher capacity of batteries. One such composite oxide is xLi₂MO₃-(1−x)LiMeO₂, which principally includes a solid-solution complex consisting of Li₂MO₃ and LiMeO₂. In a case of Li₂MO₃ constituting the solid-solution complex, manganese (Mn) has an oxidation state of 4+ during an initial charge cycle, and the redox potential of Mn^{4+/5+} is below the top of the oxygen band, thus, not allowing Mn to contribute to electric conductivity.

However, oxygen and lithium are deintercalated from the crystal lattice of the solid-solution complex, during an initial charge cycle, and the deintercalated lithium reacts with Mn^{3+/4+}, during a following discharge cycle, thereby achieving a high capacity. During this process, the crystalline structure may become unstable, thereby deteriorating cycle life characteristics, during high voltage charge/discharge cycles. Therefore, there is a need to improve cycle characteristics of the cathode active material, while maintaining the composite oxide at a high-capacity performance level.

### SUMMARY OF THE INVENTION

Aspects of the present invention provide a high-capacity cathode having improved cycle characteristics.

Aspects of the present invention also provide a lithium battery using the high-capacity cathode.

Additional aspects and/or advantages of the invention will be set forth, in part in the description which follows and, in part, will be obvious from the description, or may be learned by practice of the invention.

### BRIEF DESCRIPTION OF THE DRAWINGS

These and/or other aspects and advantages of the invention will become apparent, and more readily appreciated, from the following description of the exemplary embodiments, taken in conjunction with the accompanying drawings, of which:

FIG. 1 is a FT-IR graph of a carbon-coated Al₂O₃ prepared in Example 1;

FIG. 2 illustrates 0.5 C charge-discharge cycle characteristics, of cells according to Comparative Examples 1 to 3, and Examples 1 and 2 of the present invention, within the range of measured potential of 2.0 to 4.55 V vs. Li⁺/Li; and

FIG. 3 is a graph illustrating the capacity retention ratios of cells, according to Comparative Examples 1 to 3, and Examples 1 and 2, after 50 cycles.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures.

The cathode, according to an aspect of the present invention, includes: a cathode active composition including a conducting agent, a binder, and a (cathode) active material, coated on one plane of a current collector. The cathode active material comprises a solid-solution composite oxide generally represented by Formula (1):

xLi₂MO₃-(1−x)LiMeO₂

In Formula (1) 0<x<1, and M and Me are each independently at least one metal selected from the group consisting of Mn, Ti, Zr, V, Cr, Mn, Fe, Co, Ni, Cu, Al, Mg, Zr, B, and Mo. The active material can be an electrochemically inactive material that is surface-coated with carbon.

The solid-solution composite oxide represented by Formula (1) has same layered structure as each component Li₂MO₃ and LiMeO₂, and excess lithium exists as a substituted form in the transition metal layer. For achieving a high capacity cathode, a preferable content of lithium existing in the transition metal layer is less than about 20%. However, the lithium reduces the proportions of elemental transition metals associated with electrical conductivity, such as Ni, or Co, resulting in a reduction in the electric conductivity. In addition, in order to achieve a high capacity, the solid-solution composite oxide should be charged at 4.5 V, or higher, relative to Li. In particular, since oxygen atoms are released from the lattice structure at around 4.5 V, a deterioration of the lattice structure is accompanied by electrolyte side reactions that occur at high voltages.

The electrochemically inactive material is included in the solid-solution composite oxide represented by Formula (1), thereby improving high-voltage stability. In addition, the surface of the electrochemically inactive material is coated with carbon, thereby preventing the electric conductivity from being reduced, which is caused by adding the electrochemically inactive material. That is to say, the electrochemically inactive material, whose surface is coated with carbon, is used with the solid-solution composite oxide represented by Formula (1), thereby improving the high-voltage stability of the lattice, while preventing the electric conductivity from being reduced. Consequently, the conductivity and high-voltage cycle characteristics of the cathode are improved, the cathode comprising the carbon-coated, electrochemically inactive material, and the solid-solution composite oxide represented by Formula (1), as a cathode active composition.

The electrochemically inactive material may be a metal oxide, a non-transition metal fluoride, or a non-transition metal phosphoride. More concretely, the metal based oxide can be exemplified by Al₂O₃, MgO, SiO₂, CeO₂, ZrO₂, and ZnO. The non-transition metal fluoride can be exemplified by AlF₃ . The non-transition metal phosphoride can be exemplified by AlPO₄. In some embodiments, a non-transition metal oxide is used, and in some embodiments Al₂O₃ is used.

The electrochemically inactive material is a particulate material that is added to the cathode active composition, and is surface-coated with carbon (carbon material). There is no particular limitation in the type of carbon material that can be coated on the surface of the electrochemically inactive material. For example, at least one selected from the group consisting of hard carbon, soft carbon, graphite, pyrolytic carbons, cokes, glass-like carbons, fired organic polymer compound bodies, carbon fibers, and activated carbon can be used as the carbon material. The cokes include pitch coke, needle coke, petroleum coke, and so on. The fired organic polymer compound bodies are polymers, such as a phenolic resin and a furan resin, which are carbonized by firing at an adequate temperature. The carbon material may have any one of a fibrous shape, a spherical shape, a particulate shape, or a flake shape.

The content of the carbon coated on the surface of the electrochemically inactive material is generally not greater than 20 wt %, and in some embodiments is preferably from 1 to 15 wt %, based on the total weight of the electrochemically inactive material. If the content of the carbon is greater than about 20 wt %, it can be difficult to achieve a desired high capacity.

There is no particular limitation in the method of surface coating the carbon material. For example, the surface coating of the carbon material can be done by performing heat treatment on the carbon material, in an organic solvent, with an alkoxide precursor of a non-transition metal.

The conducting agent included in the cathode active material composition can be carbon black. Useful examples of the binder include vinylidenefluoride/hexafluoropropylene copolymers, polyvinylidenefl uoride, polyacrylonitrile, polymethylmethacrylate, polytetrafluoroethylene, mixtures thereof, and styrene butadiene rubber polymers.

The cathode active material, the conducting agent, and the binder are used in a content ratio commonly used in the field of lithium batteries. There is no particular limitation in the current collector, as long as the collector is formed of a conductive material. As a cathode current collector, an aluminum current collector can be used. The current collector can be formed to have the size and thickness within the range commonly used in the art.

A lithium battery using the cathode, according to aspects of the present invention, can be manufactured in the following manner. Like the manufacture of the cathode, an anode active material, a conducting agent, a binder, and a solvent are mixed together to prepare an anode active material composition. The anode active material composition is directly coated on a copper current collector, and dried to form an anode. Alternatively, the anode may be manufactured by laminating an aluminum current collector, with an anode active material film that is previously formed by casting the anode active material slurry on a support. Here, the anode active material, the conducting agent, the binder, and the solvent are used in amounts within the range commonly used in the art.

Examples of the anode active material include lithium metal, a carbon material, or graphite. The anode active material, the conducting agent, the binder, and the solvent, used for the anode active material composition, may be the same as those used for the cathode active material composition. If desired, a plasticizer may be added to the cathode active material composition, and to the anode active material composition, to produce pores inside the electrodes.

The cathode and the anode can be separated by a separator. Any separator commonly known in the field of lithium batteries may be used. In some embodiments, the separator is made from a separator material having a low resistance to ion movement of the electrolyte, and good electrolyte impregnation properties. Specific examples of such separator materials include a glass fiber, polyester, TEFLON, polyethylene, polypropylene, polytetrafluoroethylene (PTEE), and a combination of the foregoing materials, which may be in non-woven fabric or a woven fabric form.

In the case of a lithium ion battery, a rolled separator made of polyethylene, polypropylene, and the like, are used. Meanwhile, in the case of a lithium ion polymer battery, a separator having good electrolyte impregnation properties is used. These separators may be manufactured in the following manner.

First, a polymer resin, a filling agent, and a solvent are mixed together, to prepare a separator composition. This separator composition is directly coated on an electrode, and dried, to form a separator film. Alternatively, the separator may be formed by laminating the electrode with a separator film, which is previously formed by casting the separator composition on a support, and drying.

Any polymer resin that can be used as a binder for electrodes. Examples of the polymer resin include a polyvinylidenefluoride-hexafluoropropylene copolymer, polyvinylidenefluoride, polyacrylonitrile, polymethacrylate, and a mixture of the foregoing materials. In some embodiments the polymer resin is a vinylidenefluoride-hexafluoropropylene copolymer containing 8 to 25%, by weight, of hexafluoropropylene. Examples of the binder include an inylidenefluoride-hexafluoropropylene copolymer, polyvinylidenefluoride, polyacrylonitrile, polymethymethacrylate, and mixtures thereof.

The separator is disposed between the cathode and the anode, manufactured as described above, to form an electrode assembly. This electrode assembly is wound or folded, and then sealed in a cylindrical or rectangular battery case. Next, an organic electrolytic solution is injected into the battery case, so that a complete lithium secondary battery is obtained.

Alternatively, the electrode assembly may be stacked to form a bi-cell structure, which is then impregnated with the organic electrolyte solution. The resulting structure is sealed in a pouch, thereby obtaining a completed lithium ion polymer battery. The organic electrolytic solution includes a lithium salt, and a mixed organic solvent including a high dielectric constant solvent and a low boiling point solvent.

Any high dielectric constant solvent commonly used in the art may be used. Specific examples thereof include cyclic carbonates, such as ethylene carbonate, propylene carbonate, or butylene carbonate, and y-butyrolactone. Further, the low boiling point solvent can be any such solvent that is commonly used in the art. Non-limiting examples thereof include chain carbonates, such as dimethyl carbonate, ethyl methyl carbonate, diethyl carbonate, or dipropyl carbonate, dimethoxyethane, diethoxyethane, fatty acid ester derivatives, and the like.

The high dielectric constant solvent and the low boiling point solvent are generally mixed in a ratio of 1:1 to 1:9, by volume. If the volumetric ratio of the low boiling point solvent to the high dielectric constant solvent does not fall within the stated range, the lithium battery can demonstrate undesirable discharge capacities, charge/discharge cycles, and lifespan.

The lithium salt is not particularly limited, provided that it is generally used for a lithium battery. The lithium salt can be at least one selected from the group consisting of LiClO₄, LiCF₃SO₃, LiPF₆, LiN(CF₃SO₂), LiBF₄, LiC(CF₃SO₂)₃, and LiN(C₂F₅SO₂)₂. The concentration of the lithium salt can be in the range of 0.5 to 2.0 M. If the concentration of the lithium salt is less than 0.5 M, the ionic conductivity of the electrolytic solution decreases, so that the performance of the electrolytic solution may be degraded. If the concentration of the lithium salt is greater than 2.0 M, the viscosity of the electrolytic solution increases, so that mobility of lithium ions may be undesirably reduced.

The cathode, according to aspects of the present invention, improves high-voltage stability, by adding the electrochemically inactive material to the solid-solution composite oxide, while preventing the electric conductivity from being reduced, by coating the surface of the electrochemically inactive material with carbon.

Aspects of the present invention will now be described, using the following examples. However, it is understood that the following examples are illustrative in nature, and that the present invention is not limited thereto.

### COMPARATIVE EXAMPLE 1

Li_{1.2}Ni_{0.16}Co_{0.08}Mn_{0.56}O₂, as an active material, and Ketchen black (EC-600JD) were mixed, in a weight ratio of 94:3. The Li_{1.2}Ni_{0.16}Co_{0.08}Mn_{0.56}O₂ was prepared by combustion synthesis, and had particles with a sub-micro diameter. A solution, of a conducting agent dissolved in N-methyl pyrrolidone and PVDF, was added to the mixture, to make a slurry having a weight ratio of the active material: the carbon conductive agent: the binder, of 94:3:3. The slurry was coated on aluminum foil, to a thickness of about 15 μm, and dried, to make a cathode. The cathode was further dried by vacuum drying. Using the cathode, a coin-type cell (CR2016 type) was fabricated to perform charge/discharge cycle tests. In fabricating cells, for a counter electrode, a lithium metal foil was used. 1.3MLiPF₆ was dissolved, in a mixed solvent of ethylene carbonate (EC) and diethyl carbonate (DEC) (volume ratio of EC:DEC=3:7), to form an electrolyte.

The cell was charged until the voltage reached 4.5V, with a constant 0.5 C current, and then maintained at a constant voltage until the current reached 0.05 C. The cell was discharged until the voltage reached 2 V, with a constant 0.2 C current.

### COMPARATIVE EXAMPLE 2

A cathode and a cell were fabricated by the same procedure as Comparative Example 1 and charge/discharge cycle tests were performed, except that Al₂O₃ was added to the cathode active material, in an amount of 1 wt %, relative to the total weight of the active material.

### COMPARATIVE EXAMPLE 3

A cathode and a cell were fabricated by the same procedure as Comparative Example 1, and the charge/discharge cycle tests were performed, except that Al₂O₃ was added to the cathode active material, in an amount of 3 wt %, relative to the total weight of the active material.

### EXAMPLE 1

A cathode and a cell were fabricated by the same procedure as Comparative Example 1, and the charge/discharge cycle tests were performed, except that carbon-coated Al₂O₃ was added to the cathode active material, in an amount of 1 wt %, relative to the total weight of the active material.

The carbon-coating was performed in the following manner. Aluminium isoproxide (Al₂O₃) was added to sucrose dissolved in an ethanol solution, stirred, and dried, followed by heat treatment at 900° C., for 1 hour, under nitrogen atmosphere. The content of the coated carbon was about 10 wt %, relative to the weight of Al₂O₃.

### EXAMPLE 2

A cathode and a cell were fabricated by the same procedure as Comparative Example 1, and charge/discharge cycle tests were performed, except that carbon-coated Al₂O₃ was added to the cathode active material, in an amount of 3 wt %, relative to the total weight of the active material. The carbon-coating was performed in the same manner as in Example 1.

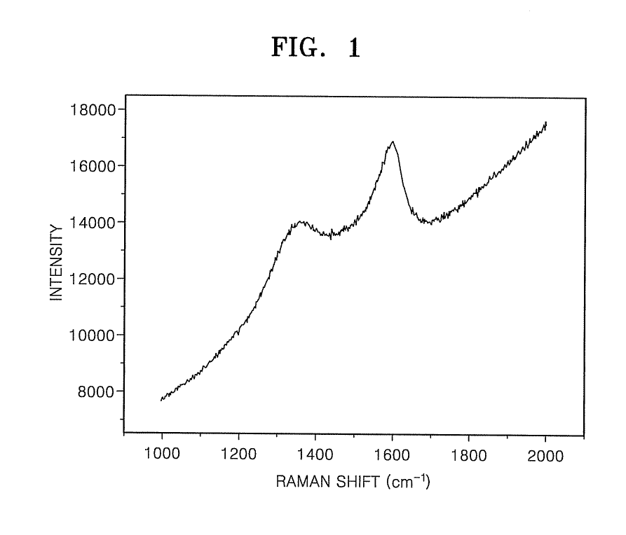

The FT-IR result, of carbon-coated Al₂O₃ prepared in Example 1, is shown in FIG. 1. When peak intensities of a D-band, positioned at about 1364 cm⁻¹, and a G-band positioned at about 1585 cm⁻¹, were compared with each other, the D/G ratio was 0.84, confirming that the carbon-coated Al₂O₃ had a graphitized structure. Therefore, even if the carbon-coated Al₂O₃, which is a non-conductor, was inserted into the cathode, an electrical conductivity drop was be prevented.

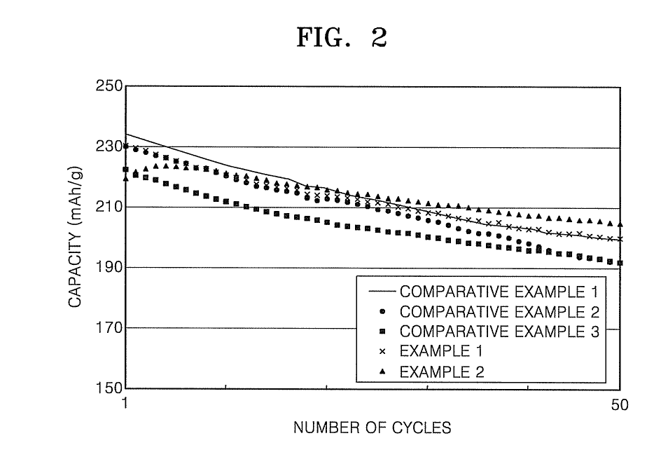

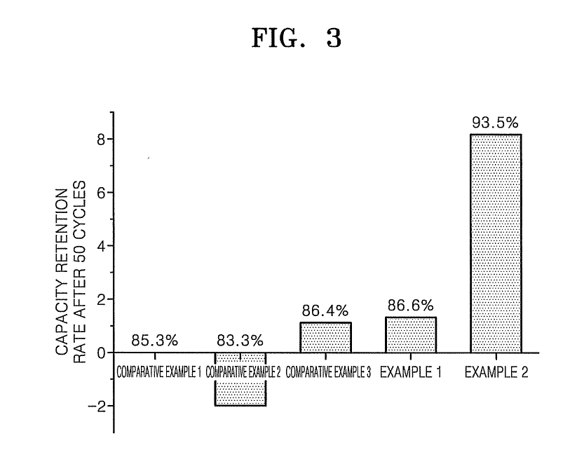

FIG. 2 illustrates 0.5 C charge-discharge cycle characteristics of cells according to Comparative Examples 1 to 3, and Examples 1 and 2, within the range of measured potential of 2.0 to 4.55 V, vs. Li. Referring to FIG. 2, as the content of the electrochemically inactive material, i.e., Al₂O₃ coated with carbon, or Al₂O₃ without carbon, increased, the capacity was reduced. However, as the content of the electrochemically inactive material increased, the number of cycles was increased, as shown in FIG. 3.

FIG. 3 illustrates the capacity retention ratios of cells, according to Comparative Examples 1 to 3, and Examples 1 and 2, after 50 cycles. After 50 cycles, Li_{1.2}Ni_{0.16}Co _{0.08}Mn_{0.56}O₂ powder, according to Comparative Example 1, in which no additional material was added to the active material, maintained 85.3% of the initial discharge capacity. In Comparative Example 2, in which 1 wt % of Al₂O₃ was added to the active material, the initial discharge capacity retention ratio was about 83.3%. In Comparative Example 3, in which 3 wt % of Al₂O₃ was added to the active material, the cycle characteristics were improved, and the initial discharge capacity retention ratio was maintained, by about 86.4%.

In Examples 1 and 2, the cycle characteristics were substantially improved, as indicated by the initial discharge capacity retention ratios 86.6% and 93.5%, respectively. This suggests that adding only Al₂O₃, which is an insulator, to the cathode active material, may deteriorate the electrical conductivity of the cathode, as compared to a case where Al₂O₃ is not added to the cathode active material. However, the deterioration in the electrical conductivity of the cathode, due to the Al₂O₃, can be sufficiently compensated for, by coating Al₂O₃ with carbon, and adding the same to the cathode active material, and the cycle characteristic of a lithium battery using the cathode containing the cathode active material can be improved.

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. A cathode comprising:
a current collector;
a cathode active composition coated on the current collector, comprising a conducting agent, a binder, and a cathode active material,
wherein the cathode active material comprises,
a solid-solution composite oxide represented by the Formula xLi₂MO₃-(1−x)LiMeO₂, wherein 0<x<1, and M and Me are each independently at least one metal selected from the group consisting of Mn, Ti, Zr, V, Cr, Mn, Fe, Co, Ni, Cu, Al, Mg, Zr, B, and Mo, and an electrochemically inactive material that is surface-coated with carbon.

2. The cathode of claim 1, wherein the electrochemically inactive material is at least one metal selected from the group consisting of a metal oxide, a non-transition metal fluoride, and a non-transition metal phosphoride.

3. The cathode of claim 1, wherein the electrochemically inactive material is at least one selected from the group consisting of Al₂O₃, MgO, SiO₂, CeO₂, ZrO₂, ZnO, AlF₃, and AlPO₄.

4. The cathode of claim 1, wherein the electrochemically inactive material is Al₂O₃.

5. The cathode of claim 1, wherein the content of the carbon is not greater than 20 wt %, of the weight of the electrochemically inactive material.

6. The cathode of claim 1, wherein Me is at least one metal selected from the group consisting of Cr, Mn, Co, and Ni.

7. The cathode of claim 1, wherein 0.1<x<0.6.

8. A lithium battery comprising:
an anode; an organic electrolytic solution; and
a current collector;
a cathode active composition coated on the current collector, comprising a conducting agent, a binder, and a cathode active material,
wherein the cathode active material comprises,
a solid-solution composite oxide represented by the Formula xLi₂MO₃-(1−x)LiMeO₂, wherein 0<x<1, and M and Me are each independently at least one metal selected from the group consisting of Mn, Ti, Zr, V, Cr, Mn, Fe, Co, Ni, Cu, Al, Mg, Zr, B, and Mo, and
a electrochemically inactive material coated with carbon.

9. The lithium battery of claim 8, wherein the electrochemically inactive material is at least one metal selected from the group consisting of Al₂O₃, MgO, SiO₂, CeO₂, ZrO₂, ZnO, AlF₃, and AlPO₄.

10. The lithium battery of claim 8, wherein the electrochemically inactive material is Al₂O₃.

11. The lithium battery of claim 8, wherein the content of the carbon is not greater than 20 wt %, of the weight of the electrochemically inactive material.

12. The lithium battery of claim 8, wherein Me is at least one metal selected from the group consisting of Cr, Mn, Co, and Ni.

13. The lithium battery of claim 8, wherein 0.1<x<0.6.

14. A cathode active composition for a cathode, comprising:
a conducting agent;
a binder; and
a cathode active material comprising,
a solid-solution composite oxide represented by the Formula xLi₂MO₃-(1−x)LiMeO₂, wherein 0<x<1, and M and Me are each independently at least one metal selected from the group consisting of Mn, Ti, Zr, V, Cr, Mn, Fe, Co, Ni, Cu, Al, Mg, Zr, B, and Mo, and
a carbon-coated electrochemically inactive material.

15. The cathode active composition of claim 14, wherein the conducting agent is carbon black.

16. The cathode active composition of claim 14, wherein the electrochemically inactive material is at least one metal selected from the group consisting of Al₂O₃, MgO, SiO₂, CeO₂, ZrO₂, ZnO, AlF₃, and AlPO₄.

17. The cathode active composition of claim 14, wherein the electrochemically inactive material is Al₂O₃.

18. The cathode active composition of claim 17, wherein the content of the carbon is not greater than 20 wt %, of the weight of the Al₂O₃.

19. The cathode active composition of claim 14, wherein Me is at least one metal selected from the group consisting of Cr, Mn, Co, and Ni.

20. The cathode active composition of claim 14, wherein 0.1<x<0.6.
